(19) United States
(12) Patent Application Publication
(10) Pub. No.: US 2024/0143874 A1
(43) Pub. Date: May 2, 2024

(54) SYSTEMS AND METHODS FOR INFORMATION VALUE-BASED PARTICLE SWARM OPTIMIZATION APPLICATIONS

(71) Applicant: Morgan Stanley Services Group Inc., New York, NY (US)

(72) Inventor: Eren Kurshan, New York, NY (US)

(21) Appl. No.: 18/049,875

(22) Filed: Oct. 26, 2022

(51) Int. Cl. G06F 30/27

(52) U.S. Cl. CPC G06F 30/27; G06F 2111/06

(57) ABSTRACT

A computing device receives, from each of a plurality of particles exploring a design space during a particle swarm algorithm iteration, particle information representing a best particle position, a best group position, and/or a local best position. Further the computing device receives, during the particle swarm algorithm iteration from the plurality of particles, additional information representing at least one of local exploration space characteristics, a number of previous iterations, and a percentage or amount of space explored by at least some of the plurality of particles. The computing device determines, using the particle information and the additional information, an information value and shares the information value to at least one of the plurality of particles. Thereafter, the computing device determines, for each of the at least one of the plurality of particles, a respective position to move, wherein the respective position is determined at least using the shared information value.

### FIELD OF THE DISCLOSURE

The present disclosure relates, generally, to information technology and, more particularly, to improving application specific problem solving using iteratively executed computing simulations.

### BACKGROUND OF THE DISCLOSURE

Optimization solutions can be applied in a wide range of application areas. Complex real-world applications, such as scientific applications, financial crime detection, and economic service applications involving wealth assessment, market analysis, investment management, and financial management, can benefit from solutions involving multi-objective optimization. One computer simulation solution is particle swarm optimization, which relies on a population of particles (sometimes termed, “candidate solutions”) that move across a respective design space to identify the global optima for a target problem. Using shared information, the candidate solutions can move at least partially collectively, which assists with the understanding and solving of complex real-world problems, including optimization techniques therefor.

Example input values to an algorithm that at least partially employs particle swarm optimization techniques (hereinafter a “particle swarm algorithm”) can include the size of the “swarm,” representing the number of candidate solutions, a function to be optimized (e.g., minimized), and a maximum number of iterations. Example outputs from the process can include a position of the minimum function value that is found as well as a value of the function at that position. A loop proceeds to initialize each respective particle with a random position and velocity, and information representing a position of a best solution discovered thus far in the process, a position of the best solution discovered by a respective neighboring particle, a mathematically derived updated velocity of the respective particle, and a mathematically derived updated position of the respective particle are provided during each iteration. Thus, each particle starts at a random position and, in each iteration, function-based evaluations are performed. If the current position of the particle is better than the previous personal best (Pbest) then Pbest is updated. Accordingly, evaluations such as a global best across the swarm (Gbest), the Pbest, and a neighborhood best (Nbest), can be provided.

Unfortunately, particle swarm optimization has certain shortcomings, including early convergence where particles converge onto a local minimum thereby impeding or preventing the algorithm from finding the global minima. Application-specific solutions include a trade-off between an exhaustiveness of the exploration and premature convergence into a local minima/maxima. Accordingly, the success of a given solution can be space dependent. Furthermore, respective optimization spaces may have a very diverse set of characteristics, for example, depending on a given application type. In some applications, geographical analogies or peaks and valleys may apply, while in others, such as a pixelated image, there may be a high number of max/min locations with no simple gradient function available for extrapolation. Early or premature convergence can, therefore, be an undesirable side effect in wide-scale global information sharing in view of one or more respective underlying, arguably greedy, processes. Limiting information sharing and forcing the algorithm to go through exploration phases or adding inertia to reduce the greedy movement towards the best solution only may be only partially effective. Premature convergence is more problematic in higher dimensional cases.

It is in regard to these and other problems in the art that the present disclosure is directed.

### SUMMARY OF THE DISCLOSURE

In one or more implementations of the present disclosure, a system and method are provided for optimizing a particle swarm process during execution of at least one application running on at least one computing device. At least one computing device receives, from each of a plurality of particles exploring a design space during a particle swarm algorithm iteration, particle information representing at least one of a best particle position, a best group position, and a local best position. Further the at least one computing device receives, during the particle swarm algorithm iteration from the plurality of particles, additional information representing at least one of local exploration space characteristics, a number of previous iterations, and a percentage or amount of space explored by at least some of the plurality of particles. The at least one computing device determines, using the particle information and the additional information, an information value and shares the information value to at least one of the plurality of particles. Thereafter, the at least one computing device determines, for each of the at least one of the plurality of particles, a respective position to move, wherein the respective position is determined at least using the shared information value. Each of the at least one of the plurality of particles moves based on the determined respective position to move. Further, the at least one computing device affects execution of the at least one application as a function of movement of each of the at least one of the plurality of particles.

In one or more implementations of the present disclosure, the additional information is generated by machine learning using at least one of historical data and application-specific data, and further wherein affecting the execution of the at least one application includes providing at information in the form of an alert or a message.

In one or more implementations of the present disclosure, the machine learning is implemented by at least one neural network-based architecture.

In one or more implementations of the present disclosure, the at least one computing device uses the information value to adjust topological and operational characteristics during the iteration of the particle swarm algorithm.

In one or more implementations of the present disclosure, determining the information value further comprises calculating, by at least one computing device for each of the particles, positional data and non-positional data. Further, the at least one computing device alters, as a function of the determined information value, exchange of information between at least two of the plurality of particles.

In one or more implementations of the present disclosure, the at least one computing device uses the information value for a respective mode of operation for sharing the information value.

In one or more implementations of the present disclosure, the respective mode of operation includes a collaborative mode of operation and a competitive mode of operation.

In one or more implementations of the present disclosure, the at least one computing device uses the information value to adjust some subgroups to disperse, randomize and/or assign at least one of the plurality of particles to a different subgroup.

In one or more implementations of the present disclosure, the at least one computing device forces, as a function of the information value, at least one subgroup of the plurality of particles to disperse, randomize, or be assigned to at least one different subgroup.

In one or more implementations of the present disclosure, the at least one computing device ranks the at least one subgroup of the plurality of particles based on the at least one subgroup's effectiveness.

In one or more implementations of the present disclosure, a system and method are provided for optimizing a particle swarm algorithm at run-time using information value. At least one computing device receives from each of a plurality of particles exploring a design space during a particle swarm algorithm iteration, particle information representing at least one of a best particle position, a best group position, and a local best position. The at least one computing device receives, during the particle swarm algorithm iteration from the plurality of particles, additional information representing at least one of local exploration space characteristics, a number of previous iterations, and a percentage or amount of space explored by at least some of the plurality of particles. The at least one computing device determines, using the particle information and the additional information, an information value. Further, the at least one computing device determines characteristic information representing at least one of: a weight of a signal received from at least some of the plurality of particles; at least one radius of connectivity; a group of particles, a subgroup of particles, or a swarm-level topology selection; and a number of subgroups, groups, neighborhoods, clans or rings with which respective ones of the plurality of particles share information. Furthermore, the at least one computing device alters the particle swarm algorithm as a function of the characteristic information by at least one of: optimizing, by the at least one computing device using the information value, specific information that is exchanged between particles; increasing or decreasing information propagation in a hierarchy of particles; changing the information value based on storage of significant positions; optimizing a number of historical stored positions based on the information value; changing at least one particle group assignment; and optimizing randomization using the information value.

In one or more implementations of the present disclosure, the swarm-level topology section includes at least one of two connections per node and all connected nodes.

Any combinations of the various embodiments and implementations disclosed herein can be used. These and other aspects and features can be appreciated from the following description of certain embodiments together with the accompanying drawings and claims.

### BRIEF DESCRIPTION OF THE DRAWINGS

FIG. 1 illustrates example topologies in particle swarm algorithm processes.

FIGS. 2A and 2B illustrate a comparison of example output representing landscapes in iterations of one or more particle swarm algorithms.

FIG. 3 is a diagram representing an example iteration of three subgroups of particles during a particle swarm algorithm.

FIG. 4 is a diagram representing another example iteration of three subgroups of particles, during a particle swarm algorithm.

FIG. 5 is a diagram representing another example iteration of three subgroups of particles, during a particle swarm algorithm.

FIG. 6 illustrates an example landscape associated with one group/subgroup during an iteration i of a particle swarm algorithm.

FIG. 7 is a flow diagram showing a routine of a broad aspect of information value-based particle swarm algorithm operations, in accordance with an example implementation of the present disclosure.

FIG. 8A is a flow diagram showing a routine of a broad aspect of information value-based particle swarm algorithm operations, in accordance with an example implementation of the present disclosure.

FIG. 8B is a block diagram illustrating a hybrid generative adversarial reinforced learning network, in accordance with an example implementation of the present disclosure.

FIG. 9A is a flow diagram showing a routine including broad aspects of information value-based particle swarm algorithm operations, in accordance with an example implementation of the present disclosure.

FIG. 9B is a flow diagram showing routine, including additional details in an information value-based particle swarm algorithm operation, in accordance with an example implementation of the present disclosure.

FIG. 9C is a flow diagram that illustrates additional details in an information value-based particle swarm optimization operation, in accordance with an example implementation of the present disclosure.

FIG. 10 is a flow diagram showing routine that illustrates broad aspects of information value-based particle swarm algorithm operations, in accordance with an example implementation of the present disclosure.

FIG. 11 is a flow diagram showing routine including aspects of information value-based particle swarm algorithm operations, in accordance with an example implementation of the present disclosure.

FIG. 12 is a flow diagram showing routine including aspects of information value-based particle swarm algorithm operations, in accordance with an example implementation of the present disclosure.

FIG. 13 is a flow diagram showing routine including aspects of information value-based particle swarm algorithm operations, in accordance with another example implementation of the present disclosure.

FIG. 14 is a diagram illustrating an example hardware arrangement that is configured for providing the systems and methods shown and described herein.

FIG. 15 shows an example information processor and/or user computing device that can be used to implement the techniques described herein.

FIG. 16 is a block diagram illustrating computing resources that are configurable as a form of a cloud computing platform, in accordance with an example implementation of the present disclosure.

It is noted that the drawings are illustrative and not necessarily to scale, and that the same or similar features may not have the same or similar reference numerals throughout.

### DETAILED DESCRIPTION OF CERTAIN EMBODIMENTS OF THE DISCLOSURE

By way of overview and introduction, the present disclosure presents technical method(s) and system(s) that improve upon particle swarm algorithms. The present disclosure includes systems and methods that address early convergence and other shortcomings associated with particle swarm optimization, and improves the effectiveness of particle swarm algorithms, more generally. One or more implementations of the present disclosure provide particle swarm algorithm solutions that include selection of a near-optimal topology, which balances the local and global information flow. A selection of one or more global topologies that connect all particles can result in particles converging too fast, resulting in challenges moving past suboptimal points to the global optimal. Moreover, features of the present disclosure address local topologies speed and addressing challenges of connecting local groups. While examples and implementations herein regard optimizing and improving particle swarm optimization methodology for financial services applications, it is to be appreciate that aspects of the present the proposed approach can be applied in other application domains as well.

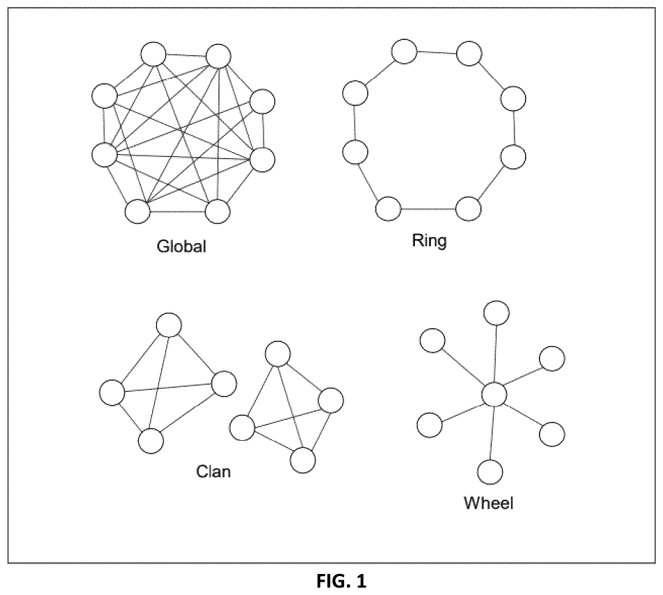

FIG. 1 illustrates example topologies in particle swarm algorithm processes. For example, in a global topology all particles are connected during the particle swarm algorithm solution process. While effective to propagate information, a global topology frequently leads to premature convergence. Alternatively, in a local topology, particles are connected to their n immediate neighbors for disseminating information. For example, if they are connected to 2 immediate neighbors for disseminating information, the resulting topology becomes a ring. Alternatively, in a Von Neumann topology, each particle is connected to 4 immediate neighbors for disseminating information. In a wheel topology, only one particle is selected to connect to each of the others and provide for information flow. In yet another alternative, a cluster topology can include four particle subgroups, where each subgroup operates according to the global topology and communicates to other subgroups through the respectively selected particles.

In accordance with one or more implementations of the present disclosure, a clan topology is used, in which the swarm operates at the subgroup level and particles in each clan disseminate information via the global topology. Thereafter, the best of the clan is selected and becomes the lead. In yet another alternative topology, a multi-ring topology connects n ring layers to each other, such that each layer has the same number of particles and communication is performed through Von Neumann topology, where the first and last layers do not communicate. In one or more implementations of the present disclosure, a respective topology can be dependent on respective criteria, including a mix of local topologies (such as four clusters, multi-ring, or the like).

The present disclosure improves upon particle swarm applications, including by determining a value associated with information, referred to herein, generally, as an “information value.” Information representing aspects of a particle swarm algorithm can be processed by one or more computing devices during iterations in a particle swarm algorithm to calculate the information value. The information value can be determined by analyzing aspects of the particle swarm algorithm, such as local exploration characteristics (i.e., the “landscape”) in terms of its topological characteristics or predictability. For example, a landscape may be a plateau region with no minima found in the most recent N iterations and 90% of the subspace has been covered. In another example, the topology may be like image pixelation, with many local minima found scattered spatiotemporally over the exportation. In some implementations, space characteristics can be coded in terms of numeric values (e.g., representing local minima or maxima rich, flat, simple gradients, or the like). Moreover, in some implementations, space characteristics can be collected to generate global characteristics in a separate component in an optimizer process. For example, an information value for topology/landscape can be provided for a landscape type, flatness, frequency of local minima, frequency of local maxima, predictability, granularity, similarity or divergence of subregions and slope characteristics. In accordance with one or more implementations, respective landscapes are fundamentally differentiated in terms of their characteristics, and information representing the characteristics can be considered valuable and exchanged along with the particles' best position information. In this way, an algorithm can extract value out of the exploration of the particles in random areas of the geography, which provides for balancing the premature convergence challenges in particle swarm algorithm processes.

Other aspects of a particle swarm algorithm that can be factored into a determination of an information value can include a number of iterations, a percentage or amount of space explored by a subgroup at a given time. In addition, or in the alternative, information representing a percentage for the collective (or “global”) space exploration can be factored into a determination of information value. For example, determining information value can be made using information representing a historical placement of the local best (“Lbest”) in the group, a historical local best found by the same group of N entries, a shared confidence score, and a swarm information value for the Lbest shared by the subgroup. In certain instances, the swarm information value can be calculated as a collaborative function, independently. Moreover, features can be included at various levels of a hierarchy of particles, such as at a subgroup, a group, a particle, and a swarm level.

Accordingly, the present disclosure improves a particle swarm algorithm as a function of an information value, which can be used to reduce or eliminate tension between exploration factors on one hand and sharing information on the other. One or more computing devices can be configured to determine an information value for downgrading a local minima, for example, due to the amount of space explored relative to the global space, while preserving information that has been explored thus far. Similarly, providing information value during run time of a particle swarm algorithm can differentiate the value of one local minima from one or more other regions, and to identify a local minima rich subspace. In one or more implementations, information value can change per iteration. For example, as the exploration space expands and new Lbest values are obtained, Lbest information value can be updated, accordingly. Early in a particle swarm algorithm process, little may be known about an exploration space, as opposed to later in the process when most of the space has been discovered. The significance of the Lbest over the course of the process, therefore, can change as additional local topologies are explored over time.

In accordance with the present disclosure, particle swarm algorithms are improved by information value-based connectivity scheme(s), including a local connectivity scheme, which can result in more efficient local convergence. Furthermore, guides can be used to adjust numerous variations of a particle swarm algorithm. For example, a weight of a signal from one or more particles, as well as the radius, as well as a selection of a respective topology (i.e., a connectivity scheme) can be adjusted. An example guide can be a value representing multi-ring or group topologies, in which information value can be shared. Selection of a respective topology can depend at least in part on its connectivity, such as a wheel topology may be more appropriate for high value information, while a ring topology may be more appropriate for low value. As the information value from each particle is shared, its connectivity and, accordingly, the topology changes. The more valuable information a particle acquires, the more connected the particle becomes during a respective iteration and the respective topology changes.

In one or more implementations, historical data representing the personal best and group best can be processed by one or more computing devices to estimate information value during a respective (e.g., current) iteration. In some cases, this may include applying a gain function over the average of historical Pbests. In others, it may include a calculation representing the significance of a current best compared to all the other historical points (Pbests and non-Pbests). Further, information value assessment can be applied, including based on a local group and/or by groups where information has been shared. In addition, a determination can be made by one or more computing devices that one or more groups reaching similar conclusions (e.g., that find similar local best values) degrades a respective information value.

Furthermore, the sharing of information, either through multi-sharing or a respective topology, can be throttled back or expanded as a function of an initially calculated information value. Such sharing can provide feedback for one or more information sources in a subsequent iteration. Particle swarm algorithms, therefore, can be optimized as a function of shared information value. Further, randomization or reassignment can be introduced to subgroups having low information value within the most recent N iterations. Overtime, incremental improvements may result in the information value degrading, thereby improving the ability for the particle swarm algorithm to converge more efficiently.

In one or more implementations of the present disclosure, values representing Lbest positions above a predetermined information value threshold (i.e., significant positions) can be shared and/or stored. The values are usable to decide on the run of the algorithm, as well as to update values substantially continuously, as additional information about a respective landscape becomes available. Further, information value can be assigned to one or more subgroups that have identified little or no value can be extracted from one or more explored regions. Negative information, therefore, can be valued, for example, for containing key information that can be processed for improved space optimization.

In accordance with the present disclosure, shared information can be valued as a separate and independent thread. For example, shared information such as Lbest, topological categorizations of a landscape that has been searched, historical data, or other information, can be individually or collectively valued. An information value selection can be made in a collaborative or competitive mode of operation, depending, for example, on a respective phase or iteration. For the initial phases, competitive assignment may yield further exploration of the design space. In later phases, a collaborative strategy may be more useful to calculate information value. Depending on respective application characteristics and desired optimization goals, the option can be user-selected. Moreover, information value can be different, such as for a local group or for sharing across groups.

The definition and the characteristics of the information value can be customized per application. As an example, a financial application that is highly dependent on finding the absolute best value (e.g., for risk management applications), the information value description and the algorithmic parameters can be customized to match that, whereas in an application that relies on finding an approximate best value (e.g., for portfolio optimization) the information value and algorithmic parameters can be adjusted accordingly.

It will be apparent to one of ordinary skill in the art that financial services industry operations are suitable for particle swarm algorithms in a wide range of application areas. Some examples of such operations can include portfolio selection and asset allocation, pricing and hedging of options, short term financing and cash flow optimization, risk & profit co-optimization, asset and liability management. In many cases, =underlying optimization problems are multi-objective and operate in highly-complex and dynamic (e.g., changing) environments. As a result, improving accuracy and performance using one or more particle swarm algorithms is highly desirable in financial applications. Evolutionary algorithms, such as particle swarm algorithms, genetic algorithms, and =variations thereof, are widely usable in the financial services industry. While traditional particle swarm optimization can provide desirable performance characteristics in a wide range of applications, it suffers from complexities and performance challenges (such as early convergence). Information value-based particle swarm algorithms address these and other challenges, for example, by providing specific customizations to a financial application-based algorithm itself, as well as for improving the overall effectiveness as a function of information value.

In one or more implementations of the present disclosure, applications in investment management can be provided, such to provide improve wealth management associated with investment banking and capital markets, sales and trading, and investment management. For example, machine learning and artificial intelligence can be provided that include application-specific information value-based particle swarm algorithms to project the merits of respective investment opportunities. In another example, an existing range of investments can be assessed, such as to analyze short-term and long-term profitability. Investment scenarios can be identified and developed by applying results of particle swarm algorithms configured in accordance with the teachings herein, thereby improving strategy in view of projected profitability.

In addition, risk can be assessed in accordance with the present disclosure, including via one or more computer implemented applications applying information value-based particle swarm algorithms. For example, information representing the ability of an issuer to make timely principal and interest payments (i.e., credit risk) can negatively impact fixed income securities. Other risk, such as changes in interest rates (interest-rate risk), creditworthiness of an issuer, and general market liquidity (market risk) can be assessed in accordance with the teachings herein. The present disclosure improves to the ability to forecast whether bond prices may fall, or whether periods of volatility can be expected, which can result in a given portfolio generating less income. Other forms of risk that can be identified by identifying conditions that can result in mortgage and asset-backed securities being subject to early prepayment risk and a higher risk of default (i.e., liquidity risk), or whether other conditions may exist that can result in credit, market and interest rate risks.

Accordingly, one or more computer-implemented applications can provide scenario analysis that includes one or more information value-based particle swarm algorithms. Respective functions, such as associated with inflation, changing interest rates, foreign and domestic geopolitical strains, health-related outbreaks (e.g., COVID-19), interruptions in supply chain operations, or other conditions can be discovered and used to assess and predict returns, income, profitability, or the like. Upon such discovery, a graphical user interface can present an alert, a message (e.g., SMS text message), an email or other indication that identifies one or more conditions as well as options for providing information associated therewith. For example, scenario analysis can be provided using the technology shown and described herein, to provide information in an interactive basis for users' decision-making processes to identify best-case and worst-case scenarios. Such analysis can contribute to changing investment strategies, such as to pursue increasingly diversified portfolios that make up less in traditional stocks and bonds, and make up more in other assets, such as real estate, investments in infrastructure and green energy, or lower-risk hedge fund strategies to provide more attractive risk/return potentials. Other financial service-based applications can be developed, in which information a value-based particle swarm algorithm is applied, for example, to assess and generate strategies involving private credit, such as direct lending, asset-based lending.

In a non-limiting example, a company seeking to diversify is considering purchasing one or more companies and adding subsidiaries. Applying search optimization processes via an information value-based particle swarm algorithm, positive conditions associated with or representing an historically stable or growing segment are identified, including that have provided relatively easy access to financing and relatively low rates of corporate default. In accordance with the present disclosure, an information value-based particle swarm algorithm precludes an early convergence, and identifies other, potentially offsetting conditions or factors. For example, additional runs locate information associated with staffing shortages that are caused by health-related conditions, supply chain interruptions limiting access to key materials, industry impacts caused by climate change, and rapidly rising inflation impacting the investment strategy. Results from the processes can be analyzed and used in a potential investment scenario analysis, thereby improving the company's ability to determine whether such purchases represent the best investment opportunity or are otherwise recommended. Accordingly, one or more of alerts, messages, or other sources of information can be provided based on results from the particle swarm algorithmic processes, for further analysis and use.

Accordingly, the present disclosure can provide applications that provide for improved interactive investment management, including as a function of information value-based particle swarm algorithms operating in connection with one or more applications. The present disclosure improves future planning, including to identify and avoid or lower a likelihood of losses resulting from factors that, due to premature convergence, may have otherwise been overlooked. Machine learning and artificial intelligence resulting from an information value-based particle swarm algorithm can improve investment decisions, including with regard to assessing investment prospects, avoiding risk, and projecting returns. The present disclosure can operate to identify factors leading to outcomes that would otherwise be unforeseen in previous modeling due to early convergence leading to difficulties in forecasting, for examples, derivatives and underlying assets comprising stocks, bonds, commodities, or the like. Moreover, temporal aspects of the landscape explored in respective particle swarm algorithm runs, as well as time dependent characteristics thereof, can impact information value.

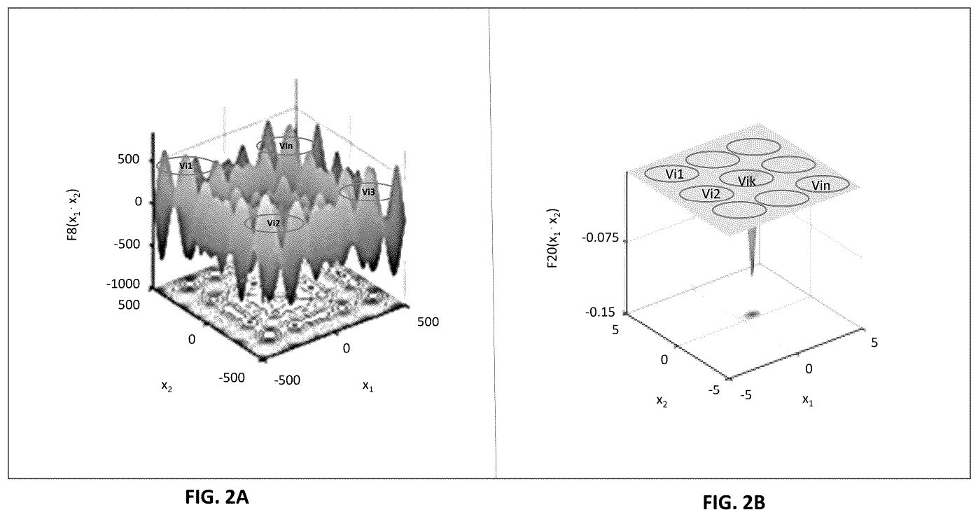

FIGS. 2A and 2B illustrate a comparison of example output representing landscapes in iterations of one or more particle swarm algorithms. The different landscapes result of information value-based particle swarm algorithm processes. For example, the landscape shown in FIG. 2A represents different groups (Vi1-Vin), which do not have significant information value to broadcast or share, regardless of the searched topology. In such case, increased connectivity among subgroups does not provide any meaningful gain in information value. In contrast, the landscape shown in FIG. 2B is a result of Vik having a high value information value to broadcast or share and is, accordingly, connected to more subgroups than any of Vi1-Vin.

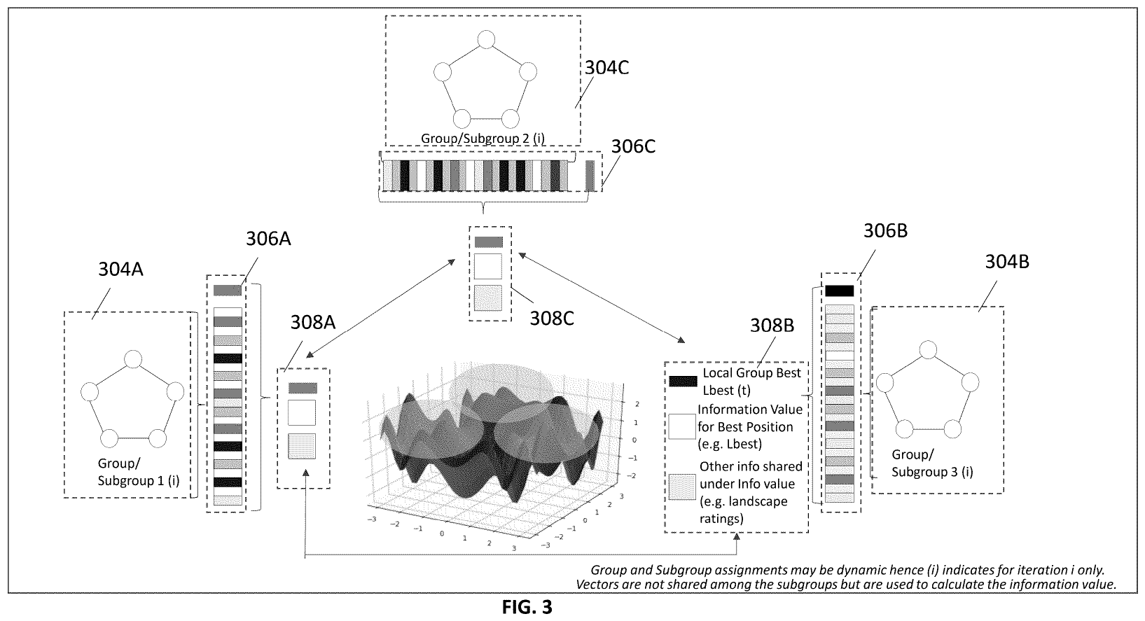

The shaded elliptic regions or assignments illustrated in FIGS. 2A-2B and in FIG. 3, etc., are for illustration purposes. The particles can be assigned quite randomly over the landscape. The regional assignments are shown to clarify the visualization and represent examples. In some embodiments of particle swarm algorithms, there may be regional assignments, whereas in others the exploration and assignments may be random (in these cases the topology information exchange may be performed by compiling available information).

The present disclosure provides a solution by ensuring efficient and effective selections of topology for propagating information content, including by determining topology, a propagation radius, and a weight or value assigned to a determined importance of a signal, based at least on information value and information content.

In operation during a particle swarm algorithm in accordance with the present disclosure, a particle or group calculates its current best position and the value of the information to be shared with other particles. The information value can be customized as a function, during the particle swarm algorithm initiation, including with application-specific characteristics. An information value can be a static function, such as representing the importance of the latest state information with respect to the history of the particle or the group, as propagated up to that point in the process. For example, the gain or delta over the most recent Pbest can be used as the value of information. Alternatively, the delta improvement over the last N Pbests can be used as the value of information. As in a multiple group approach, a particle or group of particles can be connected to one or more other groups vis-à-vis a respective topology.

In accordance with the present disclosure, information value can be calculated with respect to a given hierarchy, for example, at the particle level, the subgroup level, the group level, and up to the global. By calculating the information value hierarchically, the shared best positions and their respective value at different levels of the hierarchy can be optimized, which can be used to improve efficiency over standard particle swarm optimization, such as to prevent premature convergence or to locate the global minima efficiently.

As noted herein, positive and negative information sharing is supported in implementations of the present disclosure. Particle swarm algorithms implementing information value-based processes can acknowledge that information sharing has both positive and negative consequences. Although particle swarm algorithms rely on information sharing, for the particles to coordinate or cooperate with each other, sharing of information can cause premature convergence by pushing all particles in the same region. For example, propagation of information promising a local minima or maxima can result in negative consequences (e.g., premature convergence). The present disclosure addresses and reduces or eliminates such concerns by generating and transmitting information that is usable to provide context and improved operations. For example, beyond merely sharing best positions, each hierarchical entity, including a particle, subgroup, group, or the like, provides information representing the value of the position shared with others (e.g., other particle, subgroup, group, or the like). This information adds context to information representing, for example, shared best positions, and may be a simple function representing a respective local best as the top performer in the most recent N iterations and among the last M Lbest positions. Notwithstanding the simplicity of this example, much more complex functions are envisioned and supported by the present disclosure. For example, the function may represent that a respective min or max is the best found within the last four iterations among the last five Lbest positions. As expressed in natural language, the mathematical function may capture the historical and statistical significance of the latest value, such as there is nothing in the K percent neighborhood (as it is the strongest) across a search space of XYZ over J iterations. Further, landscape information can be incorporated, such as for the given local landscape explored, and the local minima/maxima is highly important. As illustrated in FIG. 2B, the region is represented mostly as a plateau, with no other reported local max/min.

In dynamic optimization cases where the explored landscape is not static, but changes over time, the information value can also include temporal aspects of the landscape explored and the time dependent characteristics in its information value definition.

Turning now to FIG. 3, a diagram representing an example iteration i of three subgroups of particles during a particle swarm algorithm is provided. As shown in FIG. 3, a respective landscape 302 is illustrated representing particle swarm algorithm process as optimized as a function of information respectively shared by the three subgroups 304A, 304B, 304C. Each of a plurality of particles within the respective subgroups provides information 306A, 306B, and 306C, such as a Pbest position and an information value for the Pbest. Other information associated with information value, such as landscape ratings, can further be provided and shared.

Continuing with reference to the example particle swarm algorithm process shown in FIG. 3, during iteration i, Group/Subgroup 304A provides respective best position information 306A and information value. Moreover, Group/Subgroup 304B, during the same iteration i, provided respective information and information value 306B. Still further, Group/Subgroup 304C, during the same iteration i, provided respective information and information value 306C. For each respective ones of Group/Subgroup 304A, 304B, and 304C, selections of information 308A, 308B, and 308C, respectively, are made including information representing the local group best (“Lbest”), the information value for Lbest, as well as other information shared such as landscape ratings. As shown in FIG. 3, sharing of information from selections 308A, 308B, and 308C is processed by one or more computing devices, including to optimize the particle swarm algorithm run used by the respective application.

Continuing with reference to FIG. 3, the landscape 302 graphically represents the particle swarm algorithm process during iteration i comprised in the respective groups. Information 308A, 308B, and 308C can include Lbest, information value, and other information (such as landscape characteristics, ratings, or the like) respectively selected from 306A, 306B, and 306C, respectively, for optimizing the process for the groups/subgroups 304A, 304B, and 30C, respectively. The assignments of particles to the respective groups and subgroups can be dynamic, including from iteration to iteration. In one or more implementations of the present disclosure, vectors are not shared among the subgroups, but are used in the calculation of the information value.

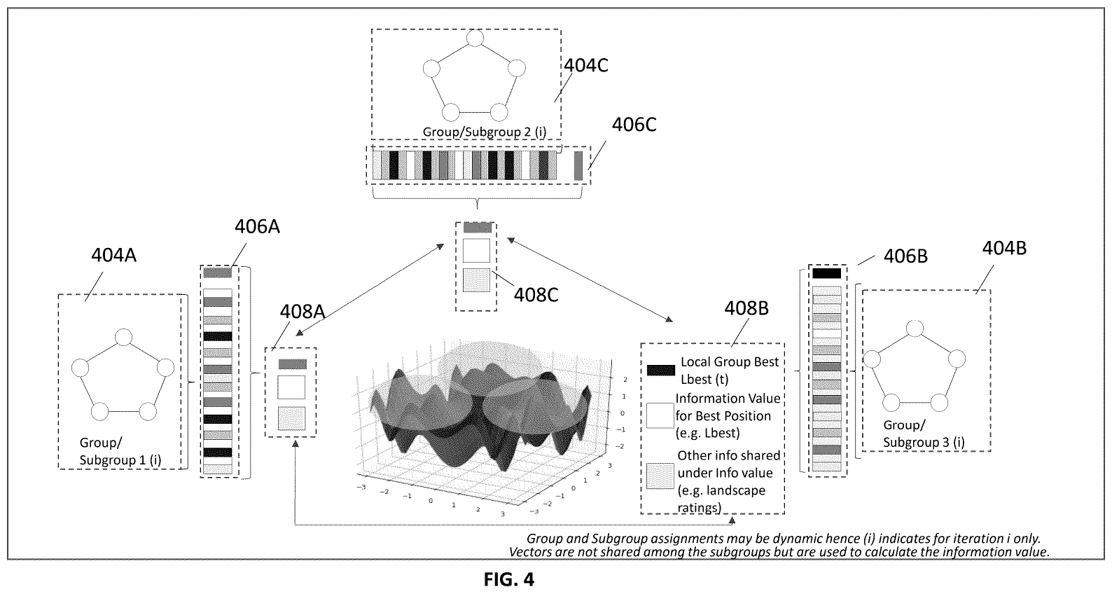

FIG. 4 is a diagram representing another example iteration i of three subgroups of particles 404A, 404B, 404C, during a particle swarm algorithm. As shown in FIG. 4, a respective landscape 402 is illustrated representing particle swarm algorithm process as optimized as a function of information shared by subgroup 404A. Each of a plurality of particles within the respective subgroups provides information 406A, 406B, and 406C, such as a Pbest position and an information value for the Pbest. Other information associated with an information value, such as landscape ratings, can further be provided and shared.

In the example particle swarm algorithm process shown in FIG. 4, information sharing is provided via a competitive mode. The example particle swarm algorithm configuration shown in FIG. 4 is selected to be static and orthogonal to dynamic/static particle group selection. As shown in FIG. 4, selected information 408A, including information representing the Lbest, information value for Lbest, as well as other information shared, such as landscape ratings selected from information 406A, is shared for optimization purposes.

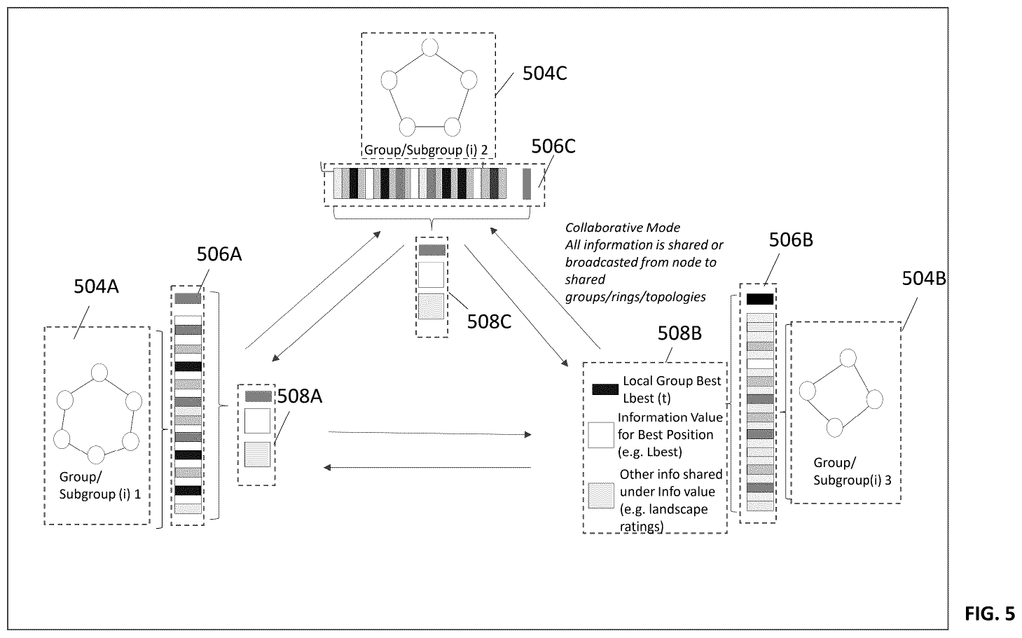

FIG. 5 is a diagram representing an example iteration i of three subgroups of particles 504A, 504B, 504C, during a particle swarm algorithm. As shown in FIG. 5, a respective landscape 502 is illustrated representing particle swarm algorithm process as optimized as a function of information shared by subgroup 504A. Each of a plurality of particles within the respective groups/subgroups provides information 506A, 506B, and 506C, such as a Pbest position and an information value for the Pbest. Other information associated with an information value, such as landscape ratings, can further be provided and shared.

In the example particle swarm algorithm process shown in FIG. 5, information sharing is provided via a collaborative mode, in which all information is shared or broadcasted from node to shared groups, rings, or typologies. The example particle swarm algorithm configuration shown in FIG. 5 is selected to be static and orthogonal to dynamic/static particle group selection. As shown in FIG. 5, selected information 508A, 508B, and 508C, including information representing the Lbest, information value for Lbest, as well as other information shared, such as landscape ratings selected from information 506A, 506B, and 506C, respectively is shared for algorithm purposes.

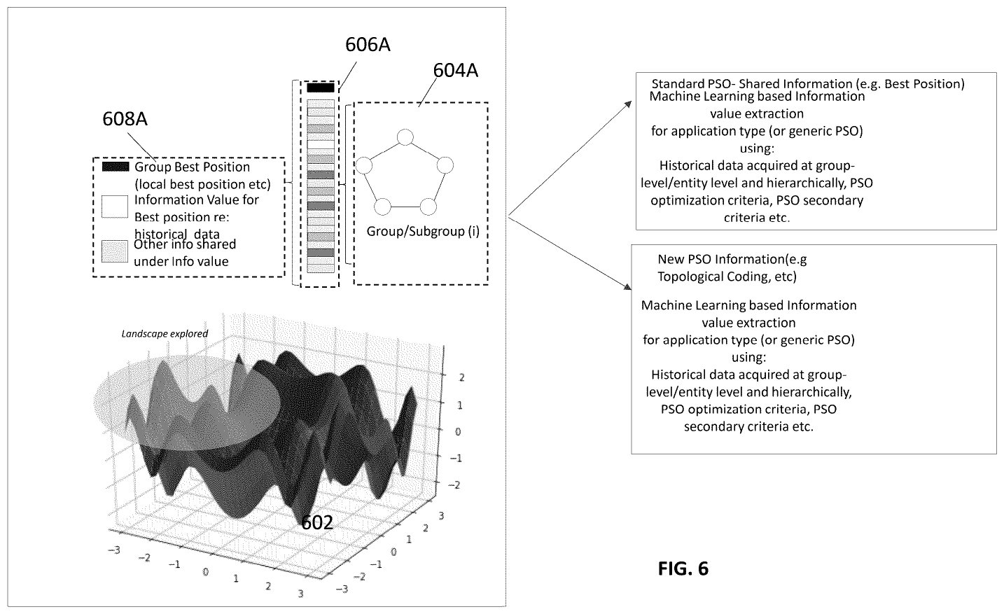

FIG. 6 illustrates an example landscape associated with one group/subgroup 604A during an iteration i of a particle swarm algorithm. The figure illustrates components of a particle swarm algorithm solution, shown and described herein, where the information value extraction for both (i) traditional particle swarm optimization shared information (such as best position) (ii) novel particle swarm algorithm shared information (such as information on the topology of the landscape) can be performed using machine learning algorithms.

As shown in FIG. 6, a solution relies on algorithmic customization of the information value for the specific application type such that the information value formulation is customized to the specific needs of the application. This meta-algorithm level optimization for information value further improves the solution performance by customizing to the underlying financial application. The optimization objectives and criteria, secondary criteria as well as historical data for the given application type is used for the machine learning optimization. In some embodiments the machine learning algorithm may be neural network based, where the primary and secondary optimization criteria for the financial application (whether it is risk optimization, portfolio management, stock trading or other), historical data at various levels of granularity and time is fed into the system to extract the customized information value for the application.

Key determinants 608A selected from particle information 606A, such as the number of iterations, space explored, and Lbest, Gbest, Nbest, or other typology, can be identified and processed, including at a high-level parametrically. Application-specific information can be extracted, such as via machine learning, including group-level and entity level historical data, and arranged in one or more hierarchies. Machine learning and artificial intelligence for providing various functionality shown and described herein can occur via neural networks, as suitably implemented by a proprietor of the present disclosure.

One or more computing devices can improve upon application performance as a function of primary and/or secondary criteria, which can be used to obtain and process information value to improve a particle swarm algorithm. Such criteria, such as application-specific criteria and topological coding information, can be used to improve efficiency beyond that of best position information, which can be misleading and inefficient, including for resource allocation. Topological coding information, for example, when processed during execution, can influence information value, notwithstanding a Pbest or other value that would otherwise influence behavior of the swarm.

The present disclosure further supports algorithmic optimization that can be based on information value for one or more implementations of particle swarm optimization. For example, information value-based local radius adjustments can be provided, including for information-value based local connectivity, radii, and typology selection. Depending on a particular iteration, any selection thereof can be customized. In operation, as the information-value from each particle is shared, the particle's connectivity is affected. For example, the more valuable the information acquired by a particle, the more connected the particle is. As with biological systems seeking food, depending on the degree of value information (e.g., caloric content) a particle (e.g., an insect) acquires, the more the particle is able to broadcast to neighbors. This approach can incorporate limits on the radius of propagation and breaks, for example, to prevent rapid convergence to a local minima. Moreover, a particle can broadcast to varying radii, for example, depending on the value of the information acquired by each particle. This iterative process can then create an information network which has both local and global advantages. The interconnectivity between two particles pi and pj can be dependent on respective information value that each particle acquires. Each particle's local and global connectivity, for example, can also be dependent on the respective information value, where strong connectivity can be created with persistent information-based evaluation of pi and pj.

Furthermore, the information value can be dynamically adjusted in each iteration, for example, as particles discover the proximity to local and global optima, and respective weights are learned and changed. Such learning process can be performed via one or more separate modules, each having processing, memory, and learning capabilities including, for example, inherent inertia with gradual learning capabilities. In one or more implementations of the present disclosure, the radii selection can be customized, based on machine learning for a given application type. For example, where the application type regards a geological search of a natural landscape, the optimal radii and topology selection may be different from an application where the lightest pixel in a large image is searched.

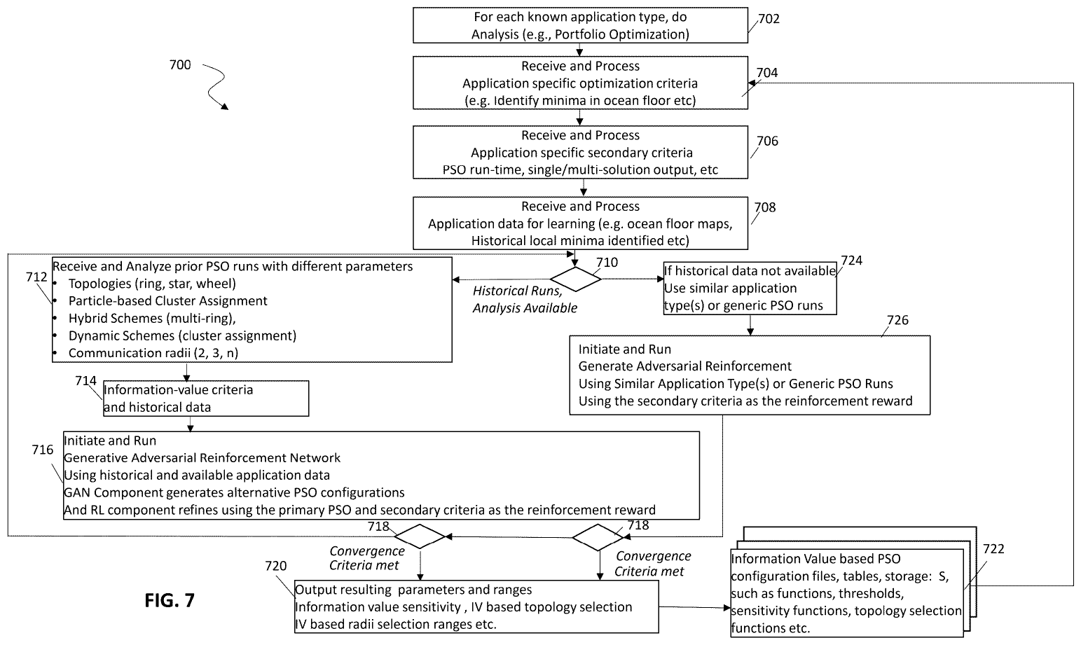

Referring, now to FIG. 7, a flow diagram is described showing a routine 700 that illustrates a broad aspect of an information value-based particle swarm algorithm in accordance with an example implementation of the present disclosure. In the example routine 700, a particle swarm algorithm parameter and information value sensitivity selection is provided using machine learning. A machine learning model can be developed (e.g., trained) to retrieve historical particle swarm algorithm data for training (e.g., through supervised learning). As a result, the machine learning can be used to optimize performance (e.g., through predicting accurate sizing requirements and reconfiguring resource allocations accordingly). It is to be appreciated that several of the logical operations described herein are implemented as a sequence of computer-implemented acts or program modules running on one or more computing devices. Accordingly, the logical operations described herein are referred to variously as operations, steps, structural devices, acts and modules can be implemented in software, in firmware, in special purpose digital logic, and any combination thereof. It should also be appreciated that more or fewer operations can be performed than shown in the figures and described herein. Machine learning operations can be implemented using neural networks, which can be implemented on traditional computing systems as well as emerging neuromorphic systems.

These operations can also be performed in a different order than those described herein.

Continuing with reference to FIG. 7 the process begins at step 702, in which a looping process begins for each known application or type. At step 704, application-specific optimization criteria, such as finding the best stock for the stock portfolio in a financial use case (or in a broader perspective identifying the minima of a given topology). Thereafter, at step 706, application-specific secondary criteria are received and processed during particle swarm algorithm run-time, in which output representing a single solution or a multi-solution is provided. Thereafter, at step 708, the process continues in which one or more computing processors receive and process application-specific data for learning (e.g., continuing with the example of identifying the minima of a given topology, the one or more processors receive and process maps that have local minima identified), as a function of historical information. Thereafter, at step 710, a determination is made whether historical runs are available for processing and further analysis.

Continuing with reference to FIG. 7, if the determination at step 710 is that information associated with historical runs is available, then the process branches to step 712 and one or more computing devices accesses information for further processing. For example, respective parameters associated with historical particle swarm algorithm runs are analyzed, as well as outcomes of the runs. In one or more implementations of the present disclosure, the respective topology, such as a ring, star, wheel, or other topology, which resulted from a particle swarm algorithm run, can be analyzed. Other information associated with a respective run, such as a particle-based cluster assignment, can also be factored, as well as whether a hybrid scheme (e.g., a multi-ring or other hybrid topology) resulted from a respective run, as well as one or more dynamic schemes (e.g., as a function of one or more cluster assignments). Moreover, a respective communication radii (e.g., 2, 3, n) can be factored into an analysis that uses information associated with prior particle swarm algorithm runs. In addition, other criteria and historical data that factored into calculating information value in a prior particle swarm algorithm run can be received and analyzed by one or more computing devices (step 714).

Continuing with reference to FIG. 7, from step 714 the process flow continues to step 716 in which the results of the analyses from steps 712 and 714 are used. Machine learning can be employed to generate and implement runs in one or more alternative particle swarm algorithm configurations. For example, a generative adversarial reinforcement network (“GAN”) such that it is initiated and run using the historical data and, when available, application-specific data in connection with the application running a particle swarm algorithm. For example, a GAN component generates alternative particle swarm algorithm configurations and a reinforced learning (“RL”) component refines the process, for example by using a primary particle swarm algorithm criteria and secondary criteria as a reinforcement reward. Thereafter, at step 716 a determination is made whether convergence criteria have been met (step 718). If so, then output is generated and provided (step 720). For example, parameters and ranges contributing to information value sensitivity can be generated and output as a function of the generative adversarial reinforcement network. Other information can include an information value-based topology, and information value-based radii selection ranges. For example, at step 722, output can be provided to information value-based particle swarm algorithm configuration files, tables, data structures, or other suitable storage. Such output can be usable for one or more future particle swarm algorithm runs as functions, thresholds, sensitivity functions, common application specific topology characteristics types, or other implementation-specific criteria. Thereafter, the process flows back to step 704 as the next known application or type is processed.

In a non-limiting example, a topology exploration on Mars may be different than on Earth in terms of generalizable characteristics, previously seen common patterns that can be learned etc. Similarly, from a financial perspective, an optimization landscape may be different in a specific geography versus another. The historical data guides the algorithm in terms of meta-heuristic level optimization of the algorithm itself.

If the analysis at step 710 results in a determination that historical data is not available, then the process branches to step 724. In particular, results from similar application type(s) for generic particle swarm algorithm runs are identified and used to initiate and run a GAN (step 726). Further, secondary criteria can be identified and used as the reinforcement reward in the respective GAN. Thereafter, the process flows to step 718, where a determination is made whether convergence criteria have been met. If so, then output is generated and provided (step 720). For example, parameters and ranges contributing to information value sensitivity can be generated and output as a function of the generative adversarial reinforcement network. Other information can include an information value-based topology, and information value-based radii selection ranges. For example, at step 722, output can be provided to information value-based particle swarm algorithm configuration files, tables, data structures, or other suitable storage. Such output can be usable for one or more future particle swarm algorithm runs as functions, thresholds, sensitivity functions, common application specific topology characteristics, types, or other implementation-specific criteria. Thereafter, the process flows back to step 704, and the next known application or type is processed. After the last known application or type is processed, the process ends.

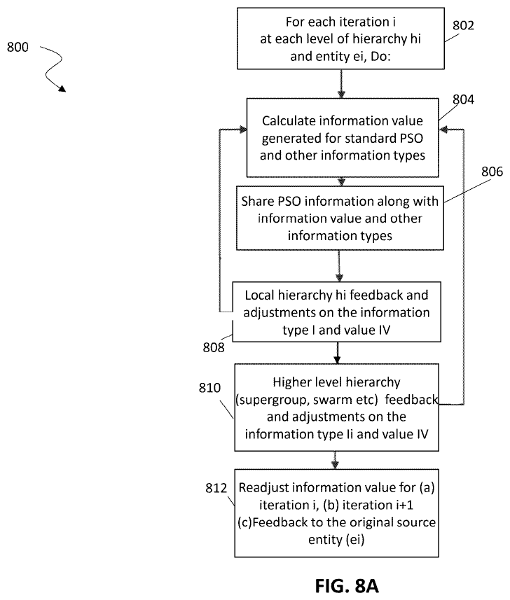

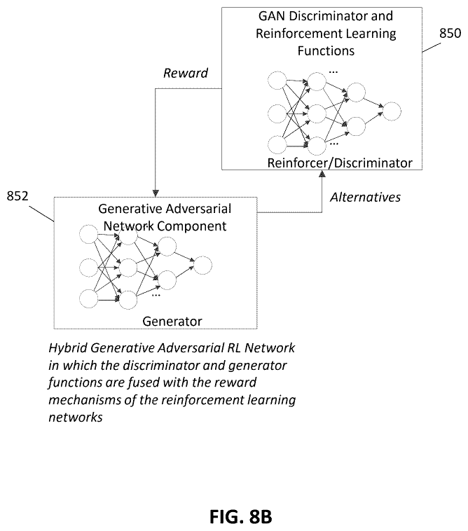

FIG. 8A is a flow diagram showing a routine 800 that illustrates a broad aspect of information value-based particle swarm algorithm operations, in accordance with an example implementation of the present disclosure. At step 802, the process begins and a loop begins for each iteration i, at each level of hierarchy (hi) and entity (entity i). At step 804, the information value is calculated, including by using standard particle swarm algorithm values as well as other information types. Thereafter, at step 806, particle swarm algorithm information, information value, and other information types is shared. At step 808, local hierarchy (hi) feedback are used to make adjustments on information type (I) and information value (IV). Furthermore, at step 810, higher level hierarchy (e.g., from a supergroup, swarm, subgroup, or other suitable level) feedback and adjustments are made to the information type (Ii) and information value (IVi). Thereafter, at step 812, the information value is readjusted for (a) iteration i, (b) iteration i+1, and (c) feedback to the original source entity (ei). Thereafter, the process ends.

One of ordinary skill will recognize the multiple self-loops, such as the self-loop over 808, operate to reduce the sequential nature of the flow chart. The local hierarchy feedback includes a continuing multi cycle process. Similarly, the loop between 810 and 808 illustrates a back and forth between the super-hierarchy feedback and same-level hierarchy feedback. In this way, the processes may not be strictly sequential, but occur with some level of simultaneity.

FIG. 8B is a block diagram that illustrates a hybrid generative adversarial reinforced learning network, in which the discriminator and generator functions 850 are fused with the reward mechanisms of the reinforcement learning networks 852. For example, the reinforcement reward output from GAN discriminator and reinforcement learning functions is usable by a generative adversarial network component. The GAN discriminator and reinforcement learning functions provide reward feedback while the generative adversarial network component (GAN) provides alternatives to refine and improve the output.

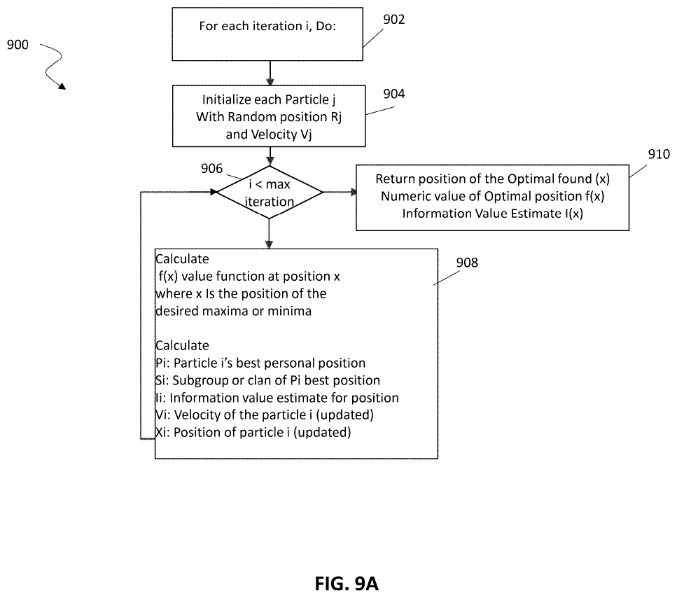

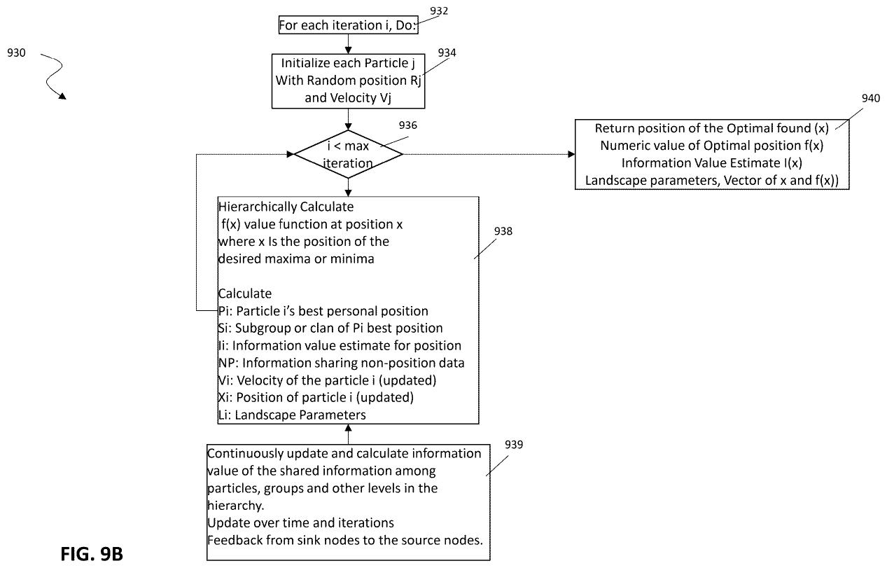

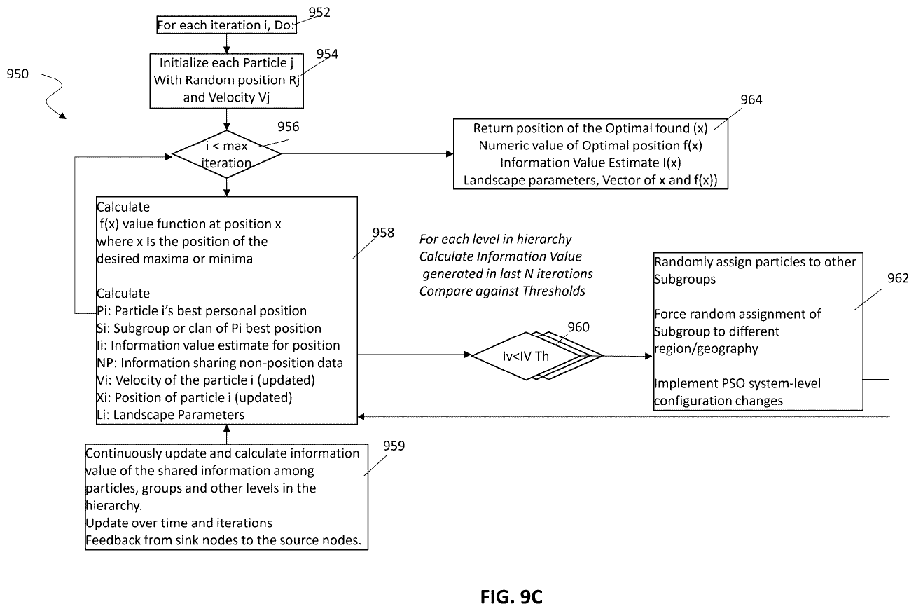

FIG. 9A is a flow diagram showing routine 900 that illustrates broad aspects of information value-based particle swarm algorithm operations, in accordance with an example implementation of the present disclosure. At step 902, the process begins and a loop begins for each iteration i. At step 904, each particle i is initialized with a random position (Rj) and velocity (Vj). Thereafter, the process flows to step 906 and a determination is made whether the respective iteration, i, is the maximum iteration. If not, then the process branches to step 908 and the standard fitness value function (ƒ(x)) is calculated at a respective position x, where x represents the position of the desired maxima or minima. More particularly, information representing a respective particle (Pi) best personal position, a subgroup or “clan” of Pi's best position, and an information value (Ii) estimate for the position is generated and, thereafter, used to update values for the velocity of Pi (Vi) and the position of Pi (Xi). Thereafter, the process loops back to step 906. In the event the respective iteration i is the maximum iteration or more broadly the stopping condition, then the process branches to step 910 and the position of the Optimal found (x), a numeric value of the optimal position (f(x)), and an information value estimate I(x) is returned.

FIG. 9B is a flow diagram showing routine 930 that illustrates more details in an information value-based particle swarm algorithm operation, in accordance with an example implementation of the present disclosure. The example routine 930 represents more complexity than the simplified example shown in FIG. 9A. At step 932, the process begins and a loop begins for each iteration i. At step 934, each particle i is initialized with a random position (Rj) and velocity (Vj). Thereafter, the process flows to step 936 and a determination is made whether the respective iteration, i, is the maximum iteration. If not, then the process branches to step 938 and a value function (ƒ(x)) is calculated at a respective position x, where x represents the position of the desired maxima or minima. More particularly, information representing a respective particle (Pi) best personal position, a subgroup or clan of Pi's best position, and an information value (Ii) estimate for the position is generated as well as information sharing non-position data (NP) which are, thereafter, used to update values for the velocity of Pi (Vi) and the position of Pi (Xi). Moreover, a value is generated that represents the landscape parameters (Li).

Continuing with reference to FIG. 9B, step 939 provides input to step 938, including by frequently updating and calculating an information value of shared information among particles, groups and other levels in the hierarchy. For example, information representing updates over time and iterations, feedback from sink nodes to the source nodes, or other suitable information can be provided. Thereafter, the process loops back to step 936. In the event the respective iteration i is the maximum iteration or the broader stopping condition is met, then the process branches to step 940 and the position of the Optimal found (x), a numeric value of the Optimal position (f(x)), an information value estimate I(x), and landscape parameters, vector of x and f(x) are returned.

FIG. 9C is a flow diagram showing routine 950 that illustrates additional details in an information value-based particle swarm algorithm operation, in accordance with an example implementation of the present disclosure. At step 952, the process begins and a loop begins for each iteration i. At step 954, each particle i is initialized with a random position (Rj) and velocity (Vj). Thereafter, the process flows to step 956 and a determination is made whether the respective iteration, i, is the maximum iteration. If not, then the process branches to step 958 and a value function (ƒ(x)) is calculated at a respective position x, where x represents the position of the desired maxima or minima. More particularly, information representing a respective particle (Pi) best personal position, a subgroup or clan of Pi's best position, and an information value (Ii) estimate for the position is generated, which are, thereafter, used to update values for the velocity of Pi (Vi) and the position of Pi (Xi). Moreover, a value is generated that represents the landscape parameters (Li).

Continuing with reference to FIG. 9C, step 959 provides input to step 958, including by frequently updating and calculating information value of shared information among particles, groups and other levels in the hierarchy. For example, information representing updates over time and iterations, feedback from sink nodes to source nodes, or other suitable information can be provided. FIG. 9C includes additional processing in connection with step 958, including looping 960, for which information value is calculated for each level in a hierarchy. In one or more implementations, information value generated within the last N iterations (e.g., 5 iterations) is calculated and compared against one or more information value threshold values (Iv<IV Th). At step 962, particles are randomly assigned to other subgroups, and a random assignment of a subgroup is forced to a different region/geography. Thereafter, particle swarm algorithm system-level configuration changes are implemented the process loops back to step 956. In the event the respective iteration i is the maximum iteration, then the process branches to step 964 and the position of the Optimal found (x), a numeric value of the Optimal position (f(x)), an information value estimate I(x), and landscape parameters, vector of x and f(x) are returned.

Thus, as illustrated in FIGS. 9A-9C, example implementations of information value-based particle swarm algorithm operations are provided, including varying degrees of specificity in accordance with the respective implementations.

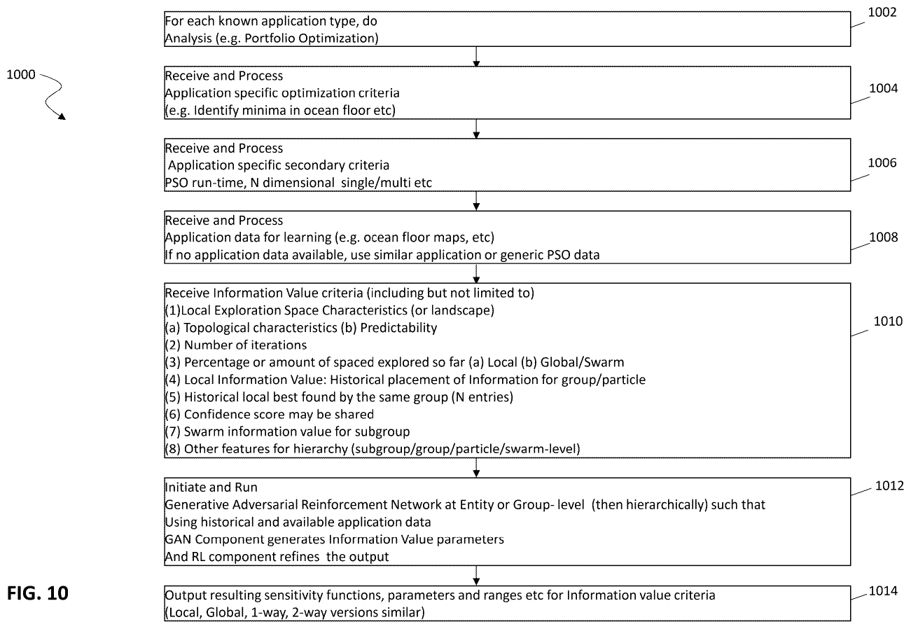

FIG. 10 is a flow diagram showing routine 1000 that illustrates broad aspects of information value-based particle swarm algorithm operations, in accordance with an example implementation of the present disclosure. At step 1002, a loop process begins for each known application or type. At step 1004, application-specific algorithm criteria, such as to identify the minima of the optimization space or finding the best stock for a specific portfolio type. Thereafter, at step 1006, application-specific secondary criteria are received and processed during particle swarm algorithm run-time, in which output representing a single solution or a multi-solution is provided. Thereafter, at step 1008, the process continues in which one or more computing processors receive and process application-specific data for learning (e.g., continuing with the example of identifying the minima of the optimization space, the one or more processors receive and process optimization space maps that have local minima identified), as a function of historical information. In the event historical or application data are not available, similar application or generic particle swarm algorithm data can be used.

Continuing with reference to FIG. 10, at step 1010 information value criteria are received or otherwise accessed by one or more computing devices. For example, local exploration space characteristics (i.e., landscape), including topological characteristics and predictability associated with a respective landscape. Other information value criteria can include a number of iterations, a percentage or amount of spaced explored, including at various levels (e.g., local, subgroup, group, global/swarm). Other information value criteria can include a local information value associated with a historical placement of information for group/particle, a historical local best found by the same group (N entries), a shared confidence score, a swarm information value for a respective subgroup, as well as other features for a respective hierarchy (e.g., at the subgroup/group/particle/swarm level).

Continuing with reference to FIG. 10, at step 1012 a generative adversarial reinforcement network (“GAN”) is initiated and run. The GAN can be at the entity or group level (hierarchically), such that historical and available application data can be used by a GAN component to generate information value parameters. Moreover, reinforced learning can be used to refine particular output, such as the information value parameters generated by the GAN component. Thereafter the process branches to step 1014, and sensitivity factors, parameters, ranges, or other suitable information can be output for respective information value criteria. Thereafter, the process ends.

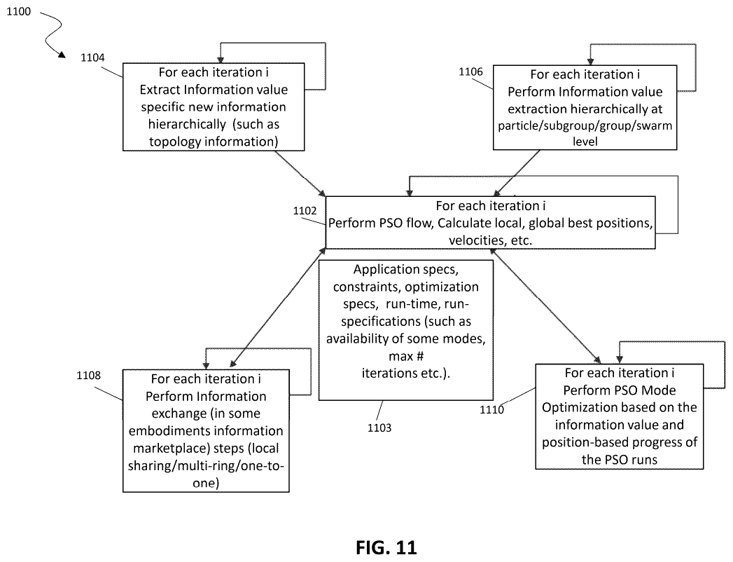

FIG. 11 is a flow diagram showing routine 1100 that illustrates aspects of information value-based particle swarm algorithm operations, in accordance with an example implementation of the present disclosure. As shown in FIG. 11, information is generated and shared via a plurality of a loop processes, including for information extraction, information value extraction and generation, information exchange, and algorithm processes, such as information representing a topology during a given iteration, for each iteration i, in a particle swarm algorithm flow. Types of information generated and shared can include information representing application specifications, application constraints, application-specific information and optimization specifications. Other types of information include information representing run-time operations and run-time specifications. For example, information representing the availability of certain modes, maximum numbers of iterations, or other operational characteristics can be generated and shared, depending on a respective process, for each iteration, various values are accessed, including local best, global best, particle velocities, or the like. As shown in FIG. 11, four respective loop processes (1104, 1106, 1108, and 1110) provide information that is used by one or more other processes and applications using particle swarm algorithm flow. For example, loop process 1104 extracts, for each iteration i, information value specific new information, hierarchically. For example, among other information extracted by process 1104, topology information is extracted and accessed by process 1102. Further, process 1106 provides, for each iteration i, information value extraction is performed hierarchically at, for example, the particle/subgroup/group/swarm level. Process 1108 provides, for each iteration i, information exchange (for example, via an information marketplace). For example, information associated with local sharing/multi-ring/one-to-one, or the like, can be extracted and/or generated. Still further, process 1110 provides, for each iteration i, particle swarm algorithm mode, based on the information value and position-based progress during particle swarm algorithm runs.

Accordingly, the present disclosure provides for particle swarm algorithm where, in addition to the standard particle swarm optimization information representing a best particle position, group best or local best positions, a custom information value or score can be calculated, shared and used for optimization. In one or more implementations, the information value changes over the number of iterations.

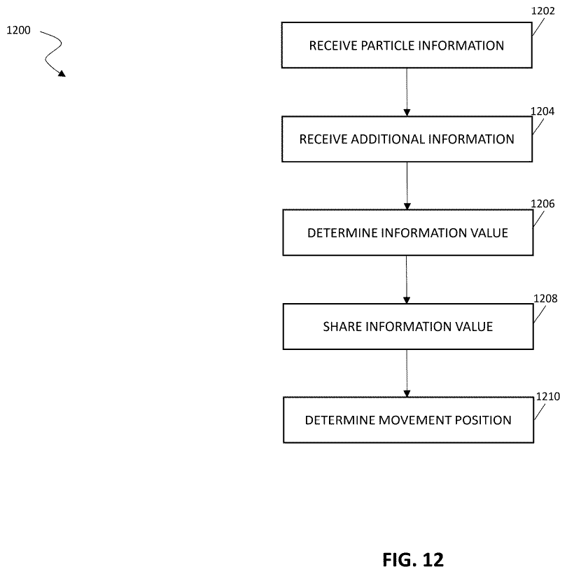

FIG. 12 is a flow diagram showing routine 1200 that illustrates aspects of information value-based particle swarm algorithm operations, in accordance with an example implementation of the present disclosure. As shown in FIG. 12, at least one computing device receives particle information representing at least one of a best particle position, a best group position, and a local best position from each of a plurality of particles exploring a design space (step 1202). Thereafter, the at least one computing device receives, during the particle swarm algorithm iteration from the plurality of particles, additional information representing at least one of local exploration space characteristics, a number of previous iterations, and a percentage or amount of space explored by at least some of the plurality of particles (step 1204). The at least one computing device determines an information value, using the particle information and the additional information (step 1206). At step 1208, shares the information value to at least one of the plurality of particles. Thereafter, the at least one computing device determines, for each of the at least one of the plurality of particles, a respective position to move, wherein the respective position is determined at least using the shared information value (step 1210).

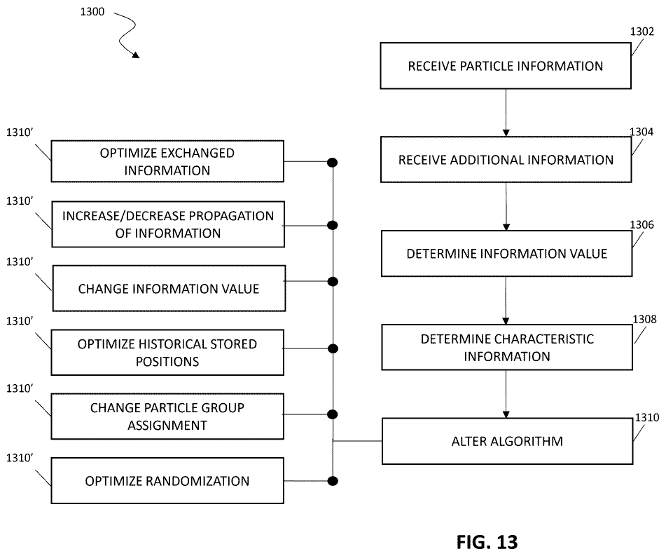

FIG. 13 is a flow diagram showing routine 1300 that illustrates aspects of information value-based particle swarm algorithm operations, in accordance with another example implementation of the present disclosure. As shown in FIG. 13, at least one computing device receives particle information representing at least one of a best particle position, a best group position, and a local best position from each of a plurality of particles exploring a design space (step 1302). Thereafter, the at least one computing device receives, during the particle swarm algorithm iteration from the plurality of particles, additional information representing at least one of local exploration space characteristics, a number of previous iterations, and a percentage or amount of space explored by at least some of the plurality of particles (step 1304). The at least one computing device determines an information value, using the particle information and the additional information (step 1306). At step 1308, the at least one computing device determines characteristic information. The characteristic information represents at least one of a weight of a signal received from at least some of the plurality of particles, at least one radius of connectivity, a group of particles, a subgroup of particles, or a swarm-level topology selection, and a number of subgroups, groups, neighborhoods, clans or rings with which respective ones of the plurality of particles share information. Thereafter, the at least one computing device alters the particle swarm algorithm as a function of the characteristic information (step 1310).

For example, the particle swarm algorithm can be altered by optimizing specific information that is exchanged between particles using the information value. In addition, or in the alternative, the at least one computing device can increase or decrease information propagation in a hierarchy of particles. Furthermore, the at least one computing device can change the information value based on storage of significant positions. Historical positions that are stored and/or exchanged and the storage capacity for analysis and future exchange can depend on the information value. As an example, these can depend on the information value average for the past N iterations for a group/subgroup. If the group/subgroup has been cultivating high information value, the storage for M historical positions may be reduced to M/2. Conversely the storage may be increased for increased information value. Accordingly, a number of historical stored positions can be optimized based on the information value, at least one particle group assignment can be changed, and randomization can be optimized using the information value.

In one or more implementations of the present disclosure, specific information can be exchanged, adjusted, and fine-tuned based on the information value. For example, for a low information value (moving average window of N past iterations) the details of the landscape topology, as well as last n best positions may not be exchanged. Alternatively, for high information value more details about the landscape topology as well as recent best positions can be exchanged in addition to the best position. Furthermore, randomization is applied in a particle swarm-based algorithm, and the frequency and the assignment characteristics for the randomization stage can be adjusted based on the information value. For groups/subgroups that have a low information value history (for a moving window of N iterations or cycles) the randomization step can be employed more frequently where the particles in these groups can be reassigned to other groups with high information value (which can be proportional to the information value extracted in the last N cycles/iterations). Both the number of particle assignments out of the low information value clusters as well as the frequency of randomization steps can be dependent on the information value.

Furthermore, and as discussed herein, the historical positions stored by the group/subgroups for information value process can be exchanged. Further, as well as storage may depend and be optimized based on information value. If a group/subgroup has not been extracted, similar information value compared to other groups/subgroups for N cycles, then the number of historical positions the group/subgroup stores about history can be optimized. More particularly, the exchange of such information with other groups/subgroups, as well as the corresponding storage dedicated to store such data can be increased or decreased (e.g., throttled up or down) based on information value.

The present disclosure provides calculation and components of information value through mathematical formulas and/or machine learning. For example, an information value is dependent on local exploration space characteristics (e.g., landscape), in terms of its topological characteristics or predictability. Further, an information value can be dependent on a number of iterations, on a percentage or amount of spaced currently explored by a subgroup. In some cases, the percentages for the collective (global) space exploration can also be factored into the calculation of information value. Still further, an information value can be dependent on a historical placement of the local best in the group, i.e., a local information value, a historical local best found by the same group (e.g., of N entries). Further, a confidence score can be calculated and shared, and a swarm information value for the Lbest shared by the subgroup can be calculated as a collaborative function independently. In one or more implementations of the present disclosure, machine learning can be used to calculate information value using historical data and application specific data.

One of ordinary skill in the art will recognize that a particle swarm algorithm can have a number of variations. An information value-based particle swarm algorithm in accordance with the present disclosure can be orthogonal to known techniques (whether the variations occur in groups/subgroups/individual particles, communication topologies and patterns, adaptiveness and time varying variations, constriction factor variations, random selection and inertia weight versions, ensembling of different particle swarm algorithm techniques in hybrid animal inspired meta-heuristics, such as bats and fireflies, or the like). The present disclosure provides an alternative view on the broad scale variants submitted and aims to balance self-exploration and converging to known best positions, through the value of the information. Information value, whether it is the value of the information from the particle itself or at various best positions at different hierarchies is a highly important decision factor. Furthermore, by expanding the information exchange beyond the limited position-based information exchange the information value definition can be improved. The resulting solution further provides more insights on the underlying optimization space. The proposed algorithm is supported and enhanced at a meta-algorithm level through machine learning for the specific application type.

In addition to using information value for the particles to locate best positions, the present disclosure can apply information value to optimize one or more operations during execution of a particle swarm algorithm. In one or more implementations, optimization meta-algorithms can operate to fine-tune the particle swarm algorithm during run-time, based on the information value, such as relating to exchanged positions and non-positional data. Examples can include a weighting value of a signal received from at least some of the plurality of particles, at least one radius of connectivity, a group/subgroup or swarm-level topology selection, and a number of subgroups, groups, neighborhoods, clans or rings with which a respective one of the plurality of particles shares information is usable for such fine tuning. Exchanged information can be optimized based on information value, and information propagation in the hierarchy, information value-based storage of significant positions, and a number of historical positions can be improved as a function of optimization meta-algorithms. Moreover, information value can impact group assignment and subgroup assignment for individual particles, and randomization steps and other particle swarm-based algorithm components can be optimized in accordance with information value.

For example, during run time a number of iterations results in certain cases and groups having low information value. In such case, one or more processes can customize (e.g., reduce) propagation of position information. Alternatively, groups with high-information value following a number of iterations can result in increasing propagating position information. Moreover, adjustments can be made through a number of functions, such as the radius of connectivity or connection topology selection, as well as the information propagation in the hierarchy. Similarly, the number of historical positions stored at the group or sub-group level can be customized based on the information value, where for high-value information the storage capacity can be increased. Similarly, group assignment and randomization stages can be optimized based on history of information value extracted by the individual particles and groups/subgroups. Such adjustments can operate to increase performance of the underlying algorithm by reducing search time, enhancing resource allocation, and increasing the likelihood of locating solutions or better solutions.

In one or more implementations of the present disclosure, information value is usable and optimization processes. More particularly, the information value can be used to calculate the best position to move each respective particle that receives the value. For example, the information value is usable to adjust the topological and operational characteristics of the particle swarm algorithm based on a calculated weight of a signal coming from the particles. In addition, a radius/radii can be defined that represents connectivity for information value. The connectivity may represent, for example, particles in multiple rings or clans or subgroups having different radii, which can be also dependent on a respective topology. Furthermore, a connectivity-level can be provided, such as a topology selection of two connections per node or where all nodes are connected. In addition, a number of subgroups, groups, neighborhoods, clans or rings in which a particle shares can be dependent on the information value.

In addition, machine learning can be used to select one or more optimization parameters for an information value-based particle swarm algorithm. For example, information value-based radius and topology optimization, as well as particle swarm algorithm parameter selection, can be done through machine learning for application types. For instance, in a natural landscape minima finding in a study, the radii, topology and subgroup selection would be learned based on the application specific characteristics. In one or more implementations of the present disclosure, such selection can be made dynamically, without prior machine learned guidance. For example, during run-time one or more computing devices executing an algorithm may decide on the gain between the iterations and change the information value criteria.

Respective modes of operation in connection with an information value-based particle swarm algorithm can be used. In such cases, the information value may be used in a collaborative mode of operation and in a competitive mode of operation, in which information value is shared to maximize utility across the groups and more within the subgroup and less across groups respectively.

Still further, machine learning is usable to calculate information value using historical data and application specific data. For example, the information value in a particle swarm algorithm process is usable to calculate the best position to move each particle that receives the value. Alternatively, or in addition, the information value is usable in a particle swarm algorithm process to adjust the topological and operational characteristics of a particle swarm algorithm, such that the weight of the signals coming from the particles can be adjusted. Furthermore, respective connectivity radius/radii (e.g., to multiple rings, clans, or subgroups) can be processed to calculate information value, depending on a respective topology. In addition, information regarding connectivity-level (e.g., two connections per node, all nodes connected, etc.), and the number of subgroups, groups, neighborhoods, clans or rings with which a particle shares information can impact a calculation of information value.

The present disclosure includes machine learning for selecting one or more parameters to calculate particle swarm algorithm information value. For example, using information value, radius and topology optimization can be performed using machine learning for respective application types. For example, in a landscape minima finding in a study the radii, topology and subgroup selection can be learned using historical data and based on application specific characteristics. In cases where machine learning is not available, information value criteria can be selected or modified during run-time, for example, based on the gain between respective iterations.

Furthermore, various modes of operation can be used based on information value. For example, the present disclosure provides a system and method for optimization in which information value can be used for collaborative mode of operation and competitive mode of operation. Information value can be shared across the landscape to maximize utility across the groups, including more within the subgroup and less across groups, respectively.

Determining information value can further be based on one or more sources. For example, information value can be determined by a process (i) initiated by an original source subgroup (ii) iterated through the consumer receiver groups and (iii) converged at the global swarm level or during a single step source-based process.

Further, the present disclosure supports information value-based randomization stages and efficiency improvement. For example, a system and method for optimization where information value is used to force some subgroups to disperse, randomize and/or be assigned to different subgroups. Subgroups produced by low information value can be ranked or rated, accordingly, for example, based on their effectiveness and, thereafter, dispersed or forced to randomize.

The present disclosure further supports one or more reward mechanisms for competitive and collaborative particle swarm optimization algorithms. For example, a particle swarm algorithm process may go through one or more sequential collaborative and competitive phases using information value, with some phases sharing the most valuable information is rewarded. In other phases, acquiring and retaining the most valuable information within local groups is rewarded.

Furthermore, information value can be calculated hierarchically, for example at the particle level, subgroup level, group level, and global level. This optimizes the shared best positions and respective value at different levels of the hierarchy.

In one or more implementations, other sources of information value can include non-position data or best particle positions (e.g., single or n-best historical data). In addition, information value can be calculated, shared and used for particle swarm algorithms for sources of data other than a best particle position. For example, topological features of an optimization landscape or landscape features, vector of significant positions (N positions), a percentage of space explored in the design space by the subgroup, group, or swarm, can contribute to calculating information value. Space characteristics associated with a landscape can be coded in terms of numeric values, such as representing local minima or maxima rich, flat, simple gradients, or the like. Furthermore, local space characteristics can be collected and used to generate global characteristics in a separate component of an optimizer.

Information value-based particle swarm algorithms can include various forms for configuration, such as tables, files, structures, or other storage. Storage of such information can be generated based on analysis using various sources, including historical data, application-level information, and generic particle swarm algorithm data and, thereafter, used during particle swarm algorithm operation. Such information can include guidelines and functions on information value assessment, information types to be shared, information representing a topology, radius change functions and criteria, thresholds for randomized assignments, or other information associated with particle swarm algorithm runs.

In one or more implementations of the present disclosure, machine learning can be used for calculating information value of the particle or groups (or subgroups) via a separate stateful algorithm, such that the information value is learned for the local entity (such as particle, group, subgroup) through machine learning. (such as via a neural network architecture). For example, machine learning can be used to assess and learn states, such as of previous best positions, significant positions, and landscape characteristics for calculating information value (e.g., a neural network architecture). Machine learning can be particularly useful to guide processes during various iterations of particle swarm algorithm processes. For example, information value and other parameters associated with a particle swarm algorithm can be calculated using historical state and memory functions. Stateful particle swarm algorithm can provide history of information value, previous states, valuable data, and adjustments over time, as well as changes in the algorithmic execution through stages. Accordingly, particle swarm algorithm parameters can be guided by historical data, application type and application-specific characteristics, as well as application specific, application type, generic particle swarm algorithm data, characteristics, optimization goals and secondary objectives, which can be assessed and learn using machine learning.

As noted herein, the present disclosure supports a generative adversarial reinforcement learning neural network, which can be configured to use a generative adversarial network to generate viable solutions and reinforcement learning reward mechanisms to refine a respective solution space. Thus, a generative component can produce potential solution outputs, which can then be refined through the reinforcement mechanisms infused.

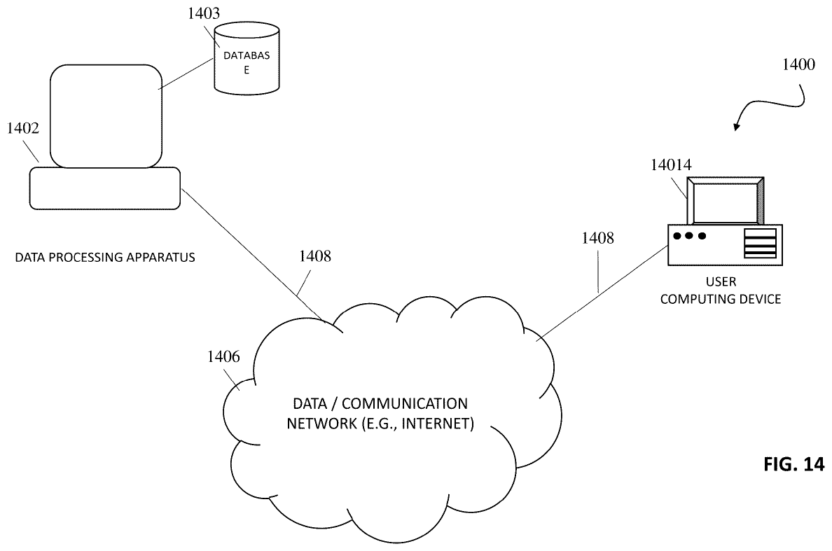

Referring to FIG. 14, a diagram is provided that shows an example hardware arrangement that is configured for providing the systems and methods disclosed herein and designated generally as system 1400. System 1400 can include one or more information processors 1402 that are at least communicatively coupled to one or more user computing devices 1404 across communication network 1406. Information processors 1402 and user computing devices 1404 can include, for example, mobile computing devices such as tablet computing devices, smartphones, personal digital assistants or the like, as well as laptop computers and/or desktop computers, server computers and mainframe computers. Further, one computing device may be configured as an information processor 1402 and a user computing device 1404, depending upon operations being executed at a particular time.

With continued reference to FIG. 14, information processor 1402 can be configured to access one or more databases 1403 for the present disclosure, including source code repositories and other information. However, it is contemplated that information processor 1402 can access any required databases via communication network 1406 or any other communication network to which information processor 1402 has access. Information processor 1402 can communicate with devices comprising databases using any known communication method, including a direct serial, parallel, universal serial bus (“USB”) interface, or via a local or wide area network.

User computing devices 1404 can communicate with information processors 1402 using data connections 1408, which are respectively coupled to communication network 1406. Communication network 1406 can be any data communication network. Data connections 1408 can be any known arrangement for accessing communication network 1406, such as the public internet, private Internet (e.g. VPN), dedicated Internet connection, or dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

User computing devices 1404 preferably have the ability to send and receive data across communication network 1406, and are equipped with web browsers, software disclosures, or other means, to provide received data on display devices incorporated therewith. By way of example, user computing device 1404 may be personal computers such as Intel Pentium-class and Intel Core-class computers or Apple Macintosh computers, tablets, smartphones, but are not limited to such computers. Other computing devices which can communicate over a global computer network such as palmtop computers, personal digital assistants (PDAs) and mass-marketed Internet access devices such as WebTV can be used. In addition, the hardware arrangement of the present invention is not limited to devices that are physically wired to communication network 1406, and that wireless communication can be provided between wireless devices and information processors 1402.

System 1400 preferably includes software that provides functionality described in greater detail herein, and preferably resides on one or more information processors 1402 and/or user computing devices 1404. One of the functions performed by information processor 1402 is that of operating as a web server and/or a web site host. Information processors 1402 typically communicate with communication network 1406 across a permanent i.e., un-switched data connection 1408. Permanent connectivity ensures that access to information processors 1402 is always available.

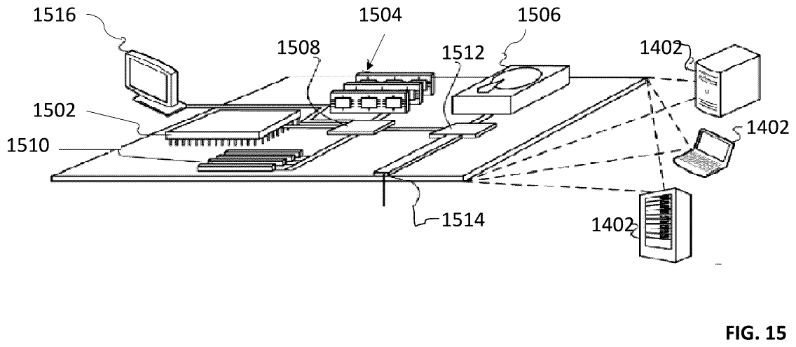

FIG. 15 shows an example information processor 1402 and/or user computing device 1404 that can be used to implement the techniques described herein. The information processor 1402 and/or user computing device 1404 is intended to represent various forms of digital computers, such as laptops, desktops, workstations, personal digital assistants, servers, blade servers, mainframes, and other appropriate computers. The components shown in FIG. 15, including connections and relationships, and their functions, are meant to be exemplary only, and are not meant to limit implementations of the inventions described and/or claimed in this document.

As shown in FIG. 15, the information processor 1402 and/or user computing device 1404 includes a processor 1502, a memory 1504, a storage device 1506, a high-speed interface 1508 connecting to the memory 1504 and multiple high-speed expansion ports 1510, and a low-speed interface 1512 connecting to a low-speed expansion port 1514 and the storage device 1506. Each of the processor 1502, the memory 1504, the storage device 1506, the high-speed interface 1508, the high-speed expansion ports 1510, and the low-speed interface 1512, are interconnected using various busses, and can be mounted on a common motherboard or in other manners as appropriate. The processor 1502 can process instructions for execution within the information processor 1402 and/or user computing device 1404, including instructions stored in the memory 1504 or on the storage device 1506 to display graphical information for a GUI on an external input/output device, such as a display 1516 coupled to the high-speed interface 1508. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 1504 stores information within the information processor 1402 and/or user computing device 1404. In some implementations, the memory 1504 is a volatile memory unit or units. In some implementations, the memory 1504 is a non-volatile memory unit or units. The memory 1504 can also be another form of computer-readable medium, such as a magnetic or optical disk.

The storage device 1506 is capable of providing mass storage for the information processor 1402 and/or user computing device 1404. In some implementations, the storage device 1506 can be or contain a computer-readable medium, e.g., a computer-readable storage medium such as a floppy disk device, a hard disk device, an optical disk device, or a tape device, a flash memory or other similar solid-state memory device, or an array of devices, including devices in a storage area network or other configurations. A computer program product can also be tangibly embodied in an information carrier. The computer program product can also contain instructions that, when executed, perform one or more methods, such as those described above. The computer program product can also be tangibly embodied in a computer- or machine-readable medium, such as the memory 1504, the storage device 1506, or memory on the processor 1502.

The high-speed interface 1508 can be configured to manage bandwidth-intensive operations, while the low-speed interface 1512 can be configured to manage lower bandwidth-intensive operations. Of course, one of ordinary skill in the art will recognize that such allocation of functions is exemplary only. In some implementations, the high-speed interface 1508 is coupled to the memory 1504, the display 1516 (e.g., through a graphics processor or accelerator), and to the high-speed expansion ports 1510, which can accept various expansion cards (not shown). In an implementation, the low-speed interface 1512 is coupled to the storage device 1506 and the low-speed expansion port 1514. The low-speed expansion port 1514, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter. Accordingly, the automated methods described herein can be implemented by in various forms, including an electronic circuit configured (e.g., by code, such as programmed, by custom logic, as in configurable logic gates, or the like) to carry out steps of a method. Moreover, steps can be performed on or using programmed logic, such as custom or preprogrammed control logic devices, circuits, or processors. Examples include a programmable logic circuit (PLC), computer, software, or other circuit (e.g., ASIC, FPGA) configured by code or logic to carry out their assigned task. The devices, circuits, or processors can also be, for example, dedicated or shared hardware devices (such as laptops, single board computers (SBCs), workstations, tablets, smartphones, part of a server, or dedicated hardware circuits, as in FPGAs or ASICs, or the like), or computer servers, or a portion of a server or computer system. The devices, circuits, or processors can include a non-transitory computer readable medium (CRM, such as read-only memory (ROM), flash drive, or disk drive) storing instructions that, when executed on one or more processors, cause these methods to be carried out.

Any of the methods described herein may, in corresponding embodiments, be reduced to a non-transitory computer readable medium (CRM, such as a disk drive or flash drive) having computer instructions stored therein that, when executed by a processing circuit, cause the processing circuit to carry out an automated process for performing the respective methods.

It is to be recognized herein that the present disclosure provides for significant technological improvements in the art, including by increasing efficiency of one or more computing platforms, including individual computing devices and distributed computing systems. The present disclosure includes options for upscaling and downscaling configuration options in accordance with respective conditions and implementations. Respective process flows can be downgraded, throttled back, or scaled in accordance with information value-based particle swarm algorithm operations. For example, by optimizing the exchange of information, increasing or decreasing propagation of information, changing information value, optimizing historical stored positions, changing particle group assignments, and optimizing randomization, as shown and described herein, computer resources are optimized, thereby improving the function of the machine, per se.

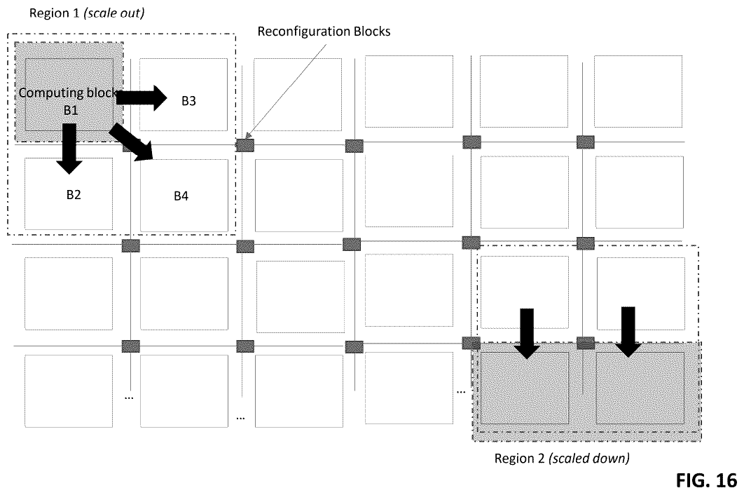

FIG. 16 is a block diagram illustrating computing resources that are configurable as a form of a cloud computing platform that includes devices, such as servers and other computing devices, as well as high-speed connection devices, such as switches, multiplexors, firewalls, or other devices (illustrated as reconfiguration blocks), that collectively make up a form of a fabric. The collection of computing devices, or regions, can be configured and reconfigured dynamically during operations, including to scale in and out more or less connections to respective devices.

As illustrated in FIG. 16, resource block b1 is shown that includes at least one computing device that can be reconfigured to connect with one or more other blocks via a respective reconfiguration block. During operation of a particle swarm algorithm, more resources may be needed and blocks can be dynamically added enabling region 1 to scale out to 4 blocks. Conversely, region 2 (FIG. 16) is illustrated in which region 2 is scaled down to 2 blocks, pursuant to resource needs during a respective operation. Accordingly, reconfiguration blocks provide for dynamic allocations and reallocations of blocks to and from regions. In addition to scaling up or down a region based on computing power, other causes for rescaling can be based on communication needs (e.g., to provide for more or less broadcasting), processing speed, storage resources (e.g., the number of blocks for storage), cache resources, memory (e.g., DRAM) resources, non-volatile memory resources, or the like. The present disclosure supports machine learning and artificial intelligence resources for assigning blocks in conventional and emerging architectures. The processing capabilities shown and described herein provide for scaling up and down processing regions, dynamically and substantially in real-time during operation.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It is further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to a viewer. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A method for optimizing a particle swarm process during execution of at least one application running on at least one computing device, comprising:
receiving, by at least one computing device from each of a plurality of particles exploring a design space during a particle swarm algorithm iteration, particle information representing at least one of a best particle position, a best group position, and a local best position;
receiving, by the at least one computing device during the particle swarm algorithm iteration from the plurality of particles, additional information representing at least one of local exploration space characteristics, a number of previous iterations, and a percentage or amount of space explored by at least some of the plurality of particles;
determining, by the at least one computing device using the particle information and the additional information, an information value;
sharing, by the at least one computing device, the information value to at least one of the plurality of particles;
determining, by the at least one computing device for each of the at least one of the plurality of particles, a respective position to move,
wherein the respective position is determined at least using the shared information value, and further wherein each of the at least one of the plurality of particles moves based on the determined respective position to move; and
affecting, by the at least one computing device, execution of the at least one application as a function of movement of each of the at least one of the plurality of particles.

2. The method of claim 1, wherein the additional information is generated by machine learning using at least one of historical data and application-specific data, and
further wherein affecting the execution of the at least one application includes providing at information in the form of an alert or a message.

3. The method of claim 2, wherein the machine learning is implemented by at least one neural network-based architecture.

4. The method of claim 1, further comprising:
using, by the at least one computing device, the information value to adjust topological and operational characteristics during the iteration of the particle swarm algorithm.

5. The method of claim 1, wherein determining the information value further comprises:
calculating, by at least one computing device for each of the particles, positional data and non-positional data; and further comprising:
altering, by the at least one computing device as a function of the determined information value, exchange of information between at least two of the plurality of particles.

6. The method of claim 1, further comprising:
using, by the at least one computing device, the information value for a respective mode of operation for sharing the information value.

7. The method of claim 6, wherein the respective mode of operation includes a collaborative mode of operation and a competitive mode of operation.

8. The method of claim 1, further comprising:
using, by the at least one computing device, the information value to force some subgroups to disperse, randomize and/or assign at least one of the plurality of particles to a different subgroup.

9. The method of claim 1, further comprising:
adjusting, by the at least one computing device as a function of the information value, at least one subgroup of the plurality of particles to disperse, randomize, or be assigned to at least one different subgroup.

10. The method of claim 9, further comprising:
ranking, by the at least one computing device, the at least one subgroup of the plurality of particles based on the at least one subgroup's effectiveness.

11. A method for optimizing a particle swarm algorithm at run-time using information value, the method comprising:
receiving, by at least one computing device from each of a plurality of particles exploring a design space during a particle swarm algorithm iteration, particle information representing at least one of a best particle position, a best group position, and a local best position;
receiving, by the at least one computing device during the particle swarm algorithm iteration from the plurality of particles, additional information representing at least one of local exploration space characteristics, a number of previous iterations, and a percentage or amount of space explored by at least some of the plurality of particles;
determining, by the at least one computing device using the particle information and the additional information, an information value;
determining, by the at least one computing device, characteristic information representing at least one of:
a weight of a signal received from at least some of the plurality of particles;
at least one radius of connectivity;
a group of particles, a subgroup of particles, or a swarm-level topology selection; and
a number of subgroups, groups, neighborhoods, clans or rings with which respective ones of the plurality of particles share information;
altering, by the at least one computing device, the particle swarm algorithm as a function of the characteristic information,
wherein altering the particle swarm algorithm includes at least one of:
optimizing, by the at least one computing device using the information value, specific information that is exchanged between particles;
increasing or decreasing information propagation in a hierarchy of particles;
changing the information value based on storage of significant positions;
optimizing a number of historical stored positions based on the information value;
changing at least one particle group assignment; and
optimizing randomization using the information value.

12. The method of claim 11, wherein the swarm-level topology section includes at least one of two connections per node and all connected nodes.

13. A computer implemented system for optimizing a particle swarm optimization process during execution of at least one application running on at least one computing device, the system comprising:
at least one computing device configured by executing instructions stored on non-transitory processor readable media to perform steps including:
receiving, from each of a plurality of particles exploring a design space during a particle swarm optimization iteration, particle information representing at least one of a best particle position, a best group position, and a local best position;
receiving, during the particle swarm optimization iteration from the plurality of particles, additional information representing at least one of local exploration space characteristics, a number of previous iterations, and a percentage or amount of space explored by at least some of the plurality of particles;
determining, using the particle information and the additional information, an information value;
sharing the information value to at least one of the plurality of particles;
determining, for each of the at least one of the plurality of particles, a respective position to move, wherein the respective position is determined at least using the shared information value and further wherein each of the at least one of the plurality of particles moves based on the determined respective position to move; and
affecting, by the at least one computing device, execution of the at least one application as a function of movement of each of the at least one of the plurality of particles.

14. The system of claim 13, wherein the additional information is generated by machine learning using at least one of historical data and application-specific data, and
further wherein affecting the execution of the at least one application includes providing at information in the form of an alert or a message.

15. The system of claim 14, wherein the machine learning is implemented by at least one neural network-based architecture.

16. The system of claim 13, wherein the at least one computing device is further configured by executing instructions stored on non-transitory processor readable media to perform steps including:
using the information value to adjust topological and operational characteristics during the iteration of the particle swarm optimization.

17. The system of claim 13, wherein determining the information value further comprises:
calculating, by the at least one computing device:
a weight of a signal received from at least some of the plurality of particles;
at least one radius of connectivity;
a topology selection; and
a number of subgroups, groups, neighborhoods, clans or rings with which a respective one of the plurality of particles shares information.

18. The system of claim 17, wherein the topology section includes at least one of two connections per node and all nodes connected.

19. The system of claim 13, wherein the at least one computing device is further configured by executing instructions stored on non-transitory processor readable media to perform steps including:
using the information value for a respective mode of operation for sharing the information value.

20. The system of claim 13, wherein the respective mode of operation includes a collaborative mode of operation and a competitive mode of operation.

21. The system of claim 13, wherein the at least one computing device is further configured by executing instructions stored on non-transitory processor readable media to perform steps including:
using, by the at least one computing device, the information value to force some subgroups to disperse, randomize and/or assign at least one of the plurality of particles to a different subgroup.

22. The system of claim 13, wherein the at least one computing device is further configured by executing instructions stored on non-transitory processor readable media to perform steps including:
forcing, as a function of the information value, at least one subgroup of the plurality of particles to disperse, randomize, or be assigned to at least one different subgroup.

23. The system of claim 22, wherein the at least one computing device is further configured by executing instructions stored on non-transitory processor readable media to perform steps including:
ranking the at least one subgroup of the plurality of particles based on the at least one subgroup's effectiveness.
